(19) United States
(12) Patent Application Publication
(10) Pub. No.: US 2025/0114757 A1
(43) Pub. Date: Apr. 10, 2025

(54) STATIC MIXER ASSEMBLY WITH A FLUID MIXING DEVICE

(71) Applicant: HINDUSTAN PETROLEUM CORPORATION LIMITED, Bengaluru (IN)

(72) Inventors: Narendiran KUMAR, Bengaluru (IN); Amit BEHERA, Bengaluru (IN); Kanuparthy Naga RAJA, Bengaluru (IN)

(21) Appl. No.: 18/398,332

(22) Filed: Dec. 28, 2023

(30) Foreign Application Priority Data
Oct. 6, 2023 (IN) 202341067242

(51) Int. Cl. B01F 25/4314; B01F 23/45; B01F 23/47; B01F 25/432; B01F 33/25

(52) U.S. Cl. CPC B01F 25/43141; B01F 23/45; B01F 23/47; B01F 25/432; B01F 33/25; B01F 2215/0422; B01F 2215/0427; B01F 2215/0431; B01F 2215/0459

(57) ABSTRACT

The present disclosure discloses a static mixer assembly (100) having a fluid mixing device (104). The fluid mixing device (104) includes a central blade (104A) having a twisted spiral structure, and a plurality of peripheral blades (104B, 104B′) each having the twisted spiral structure and abuts the central blade (104A). The twisted spiral structure of the central blade (104A) is formed in a clockwise or an anti-clockwise direction along a longitudinal axis (XX′) and the twisted spiral structure of each of the plurality of peripheral blades (104B, 104B′) is formed in an opposite direction with respect to the central blade (104A) along the longitudinal axis (XX′).

### CROSS-REFERENCE TO RELATED APPLICATION

This application is a U.S. Nonprovisional application and claims priority to Indian Application No. 202341067242, filed on Oct. 6, 2023, which is incorporated herein by reference in its entirety.

### FIELD OF THE INVENTION

The present disclosure relates to a static mixer assembly. More particularly, the present disclosure relates to the static mixer assembly with a fluid mixing device for mixing of two or more hydrocarbon fluid streams.

### BACKGROUND

Static mixer is a type of mixing equipment that is designed to blend fluids efficiently without any moving parts. Instead of using impellers or agitators like traditional mixers, static mixers rely on fixed structural elements placed inside a pipe to mix the fluids as they flow through. Due to non-requirement of external energy and mixing effectiveness, the static mixers find applications in a wide range of industries such as chemical industry, paper and pulp industry, petrochemical industry, pharmaceutical industry, semiconductor industry, optical fiber manufacturing industry, energy industry, and environment-related industry.

The conventional static mixers are typically designed for mixing fluids with lower density and viscosity. These static mixers are effective in many applications, such as emulsifying hydrocarbons in water, water treatment, chemical blending, and post-processing of industrial exhaust gases. However, when dealing with highly viscous fluids, the design of static mixers becomes more complex.

Static mixers for high-viscosity fluids often require a greater number of mixing elements which increases the risk of congealing or clogging due to the high viscosity of the fluids. Additionally, the increased complexity and number of elements may result in higher pressure drop, which is undesirable.

To address these challenges, there is a need for a simple and minimalistic fluid mixing device that could effectively mix high-viscosity fluids with minimal pressure drop.

### SUMMARY

This summary is provided to introduce a selection of concepts, in a simplified format, that are further described in the detailed description of the invention. This summary is neither intended to identify key or essential inventive concepts of the invention and nor is it intended for determining the scope of the invention.

The present disclosure discloses a fluid mixing device. The fluid mixing device includes a central blade having a twisted spiral structure, and a plurality of peripheral blades. Each of the plurality of peripheral blades has the twisted spiral structure and abuts the central blade. The twisted spiral structure of the central blade is formed in a clockwise or an anti-clockwise direction along a longitudinal axis. The twisted spiral structure of each of the plurality of peripheral blades is formed in an opposite direction with respect to the central blade along the longitudinal axis.

The present disclosure further discloses a static mixer assembly having an inner bore for mixing a first fluid stream and a second fluid stream. The static mixer assembly includes an upstream end, a downstream end, an angular conduit, and a fluid mixing device. The upstream end is adapted to allow ingress of the first fluid stream therethrough. The downstream end disposed opposite to the upstream end, adapted to allow egress of a mixture of the first fluid stream and a second fluid stream therethrough. The angular conduit is disposed in the inner bore and downstream to the upstream end, and adapted to provide the second fluid stream into the inner bore. The fluid mixing device is installed inside the inner bore, downstream to the angular conduit and upstream to the downstream end. The fluid mixing device includes a central blade and a plurality of peripheral blades. The central blade has a twisted spiral structure. Each of the plurality of peripheral blades has a twisted spiral structure and abuts the central blade. The twisted spiral structure of the central blade is formed in one of a clock-wise and an anti-clockwise direction along a longitudinal axis and the twisted spiral structure of each of the plurality of peripheral blades is formed in an opposite direction with respect to the central blade along the longitudinal axis.

The present disclosure discloses the central blade and the plurality of blades that are strategically positioned to achieve homogeneous mixing of highly viscous fluids, even within shorter distances. The present disclosure also has an improved coefficient of variance (CoV), ensures consistent and reliable mixtures, and is essential for maintaining high product quality. Additionally, the ability of the static mixer assembly to achieve effective mixing with lower pressure drop is significant thereby reducing energy consumption and operational costs. Further, the static mixer assembly offers versatility across a wide range of Reynold's numbers, ensuring consistent performance under diverse flow conditions.

Furthermore, the static mixer assembly is specifically designed for inline mixing of heavy oil hydrocarbon stream with one or more secondary heavy fluid such as dispersed catalysts, diluents, additives or combination of. The design of the static mixer assembly disclosed herein is easier to fabricate, install and maintain while providing an efficient mixing of highly viscous fluids without clogging or congealing, and thus, ensuring a smooth and consistent performance.

To further clarify the advantages and features of the present disclosure, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a schematic view of a static mixer assembly with a fluid mixing device, according to an embodiment of the present disclosure;

FIG. 2 illustrates a schematic view of the static mixer assembly with a plurality of fluid mixing device, according to another embodiment of the present disclosure;

FIG. 3a illustrates a perspective view of the fluid mixing device, according to an embodiment of the present disclosure;

FIG. 3b illustrates a perspective view of the fluid mixing device, according to another embodiment of the present disclosure;

FIG. 4 illustrates a front view of the fluid mixing device at 45 degrees elevation, according to an embodiment of the present disclosure;

FIG. 5 illustrates an isometric view of the fluid mixing device, according to an embodiment of the present disclosure; and

FIG. 6 illustrates the performance of present invention with respect to a conventional static mixer, according to an embodiment of the present disclosure.

Further, skilled artisans will appreciate that elements in the drawings are illustrated for simplicity and may not have necessarily been drawn to scale. Furthermore, in terms of the construction of the device, a plurality of components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF FIGURES

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skilled in the art to which invention belongs. The system and examples provided herein are illustrative only and not intended to be limiting.

For example, the term “some” as used herein may be understood as “none” or “one” or “more than one” or “all.” Therefore, the terms “none,” “one,” “more than one,” “more than one, but not all” or “all” would fall under the definition of “some.” It should be appreciated by a person skilled in the art that the terminology and structure employed herein is for describing, teaching, and illuminating some embodiments and their specific features and elements and therefore, should not be construed to limit, restrict, or reduce the spirit and scope of the present disclosure in any way.

For example, any terms used herein such as, “includes,” “comprises,” “has,” “consists,” and similar grammatical variants do not specify an exact limitation or restriction, and certainly do not exclude the possible addition of a plurality of features or elements, unless otherwise stated. Further, such terms must not be taken to exclude the possible removal of the plurality of the listed features and elements, unless otherwise stated, for example, by using the limiting language including, but not limited to, “must comprise” or “needs to include.”

Whether or not a certain feature or element was limited to being used only once, it may still be referred to as “plurality of features” or “plurality of elements” or “at least one feature” or “at least one element.” Furthermore, the use of the terms “plurality of” or “at least one” feature or element do not preclude there being none of that feature or element, unless otherwise specified by limiting language including, but not limited to, “there needs to be plurality of . . . ” or “plurality of elements is required.”

Unless otherwise defined, all terms and especially any technical and/or scientific terms, used herein may be taken to have the same meaning as commonly understood by a person ordinarily skilled in the art.

Reference is made herein to some “embodiments.” It should be understood that an embodiment is an example of a possible implementation of any features and/or elements of the present disclosure. Some embodiments have been described for the purpose of explaining plurality of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, plurality of particular features and/or elements described in connection with plurality of embodiments may be found in one embodiment, or may be found in more than one embodiment, or may be found in all embodiments, or may be found in no embodiments. Although plurality of features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

Embodiments of the present disclosure will be described below in detail with reference to the accompanying drawings.

The present disclosure discloses a static mixer assembly having a fluid mixing device to mix the first fluid stream with one or more secondary fluid streams. The fluid mixing device has a central blade and a plurality of peripheral blades used to mix highly viscous fluids together. The blades are strategically positioned to optimize mixing of the two fluid streams. Further, a configuration of the central blade with the plurality of peripheral blades, as disclosed in the present disclosure, allows for efficient mixing of the two fluid streams and at the same time provides precise control over the mixing process. The static mixer assembly is suitable for a wide range of industrial applications requiring homogeneous fluid mixing with minimal pressure drop.

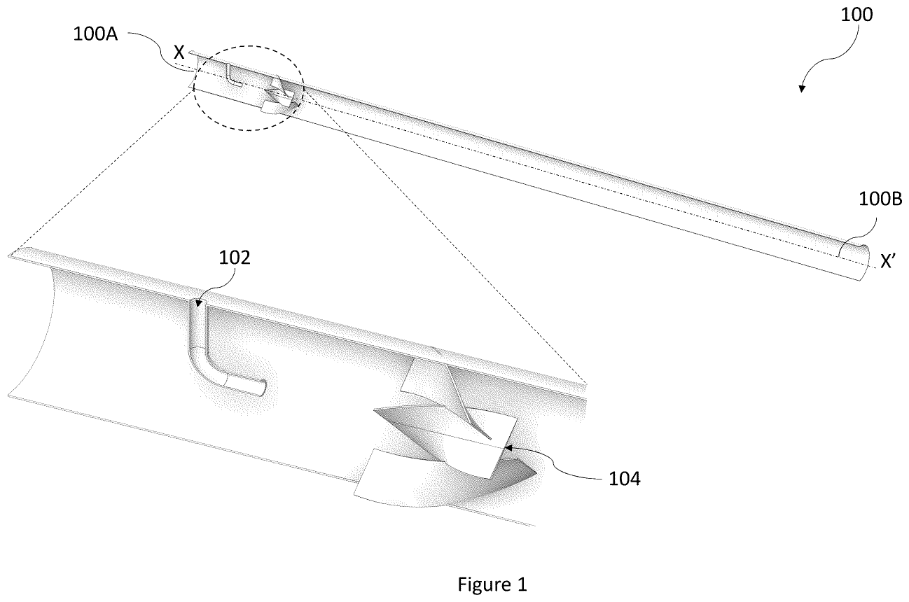

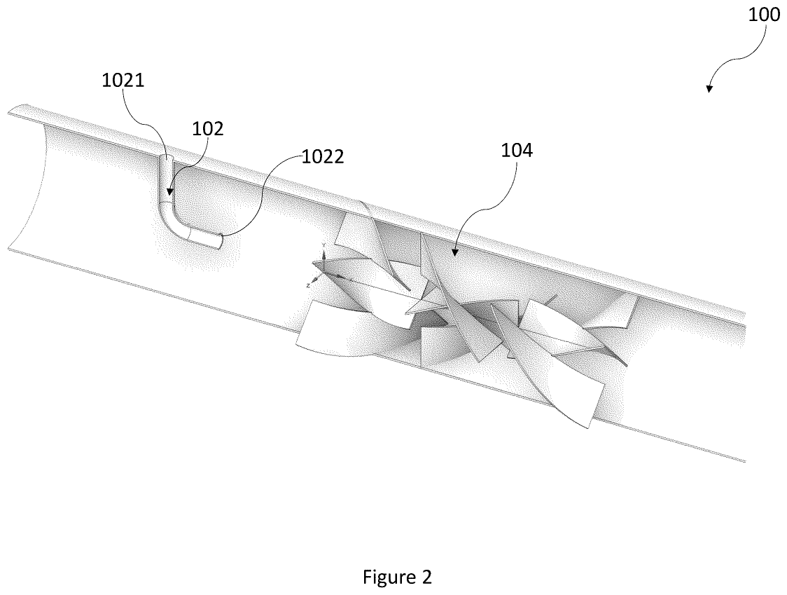

FIG. 1 illustrates a schematic view of a static mixer assembly 100 with a fluid mixing device 104, according to an embodiment of the present disclosure. FIG. 2 illustrates a schematic view of the static mixer assembly 100 with a plurality of fluid mixing devices 104, according to another embodiment of the present disclosure. Referring to FIGS. 1 and 2 together.

The static mixer assembly 100 may have an inner bore for mixing a first fluid stream and a second fluid stream. The static mixer assembly 100 may have a tubular profile. The inner bore may be a hollow channel or passage within the static mixer assembly 100, where the mixing of the first fluid stream with the second fluid stream occurs.

The static mixer assembly 100 may also have an upstream end 100A and a downstream end 100B. The upstream end 100A may be adapted to allow ingress of the first fluid stream therethrough. The downstream end 100B may be opposite to the upstream end 100A adapted to allow egress of a mixture of the first fluid stream and the second fluid stream therethrough. In other words, after the two fluids are thoroughly mixed within the inner bore, a resulting mixture may be allowed to exit through the downstream end 100B.

The static mixer assembly 100 further may have an angular conduit 102 disposed in the inner bore and downstream to the upstream end 100A. The angular conduit 102 may be adapted to provide the second fluid stream into the inner bore. The angular conduit 102 having an L-shaped profile may include an inlet 1021 adapted to ingress the second fluid stream and an outlet 1022 adapted to egress the second fluid stream. The angular conduit 102 may be adapted to supply the second fluid stream coaxial to a longitudinal axis XX′. In other words, the second fluid stream may be introduced in such a way that the flow is aligned with and concentric to the longitudinal axis XX′ of the static mixer assembly 100. The alignment ensures efficient and controlled mixing of the two fluid streams thereby contributing to the effectiveness of the static mixer assembly 100.

The static mixer assembly 100 may have the fluid mixing device 104 installed inside the inner bore, downstream to the angular conduit 102 and upstream to the downstream end 100B. A distance between the inlet 1021 of the angular conduit 102 and the fluid mixing device 104 is in a range from 0.5 to 5 times a diameter of the inner bore. An aspect ratio of the fluid mixing device 104 is in a range from 0.5 to 2 times a diameter of the inner bore. The static mixer assembly 100 caters to all viscous fluids having a wide range of Reynold's number till 400000.

The plurality of fluid mixing devices 104 may be employed within the static mixture assembly 100. There may be various combinations of disposing the plurality of fluid mixing devices 104 within the static mixture assembly 100. One example, as illustrated in FIG. 2, shows the plurality of fluid mixing devices 104 may be joined together. Each of the plurality of fluid mixing devices 104 may be rotated with a predefined minor angle with respect to each other. The predefined angle may be in a range between 45 degrees and 90 degrees. The rotational flexibility allows for a precise control over the mixing process. Therefore, the present disclosure may not be considered limiting to a specific configuration of the static mixer assembly 100 and may accommodate various alternative embodiments.

In another embodiment, each of the plurality of fluid mixing devices 104 may be positioned with a gap in between inside the static mixer assembly 100. Each of the plurality of fluid mixing devices 104 may be rotated with the predefined angle with respect to each other. The predefined minor angle may be in a range between 45 degrees and 90 degrees. In yet another embodiment, a plurality of sets of the plurality of fluid mixing devices 104 may also be employed within the static mixer assembly 100 based on a mixing requirement and pressure drop. Each set from the plurality of sets may exhibit variations in their configurations within each group, hence each set may differ from other set. The flexibility to incorporate different variations of the plurality of fluid mixing devices 104 within the static mixer assembly 100 ensures that the static mixer assembly 100 may be designed to meet a wide range of mixing needs thereby making the static mixer assembly 100 a versatile solution for diverse industrial applications.

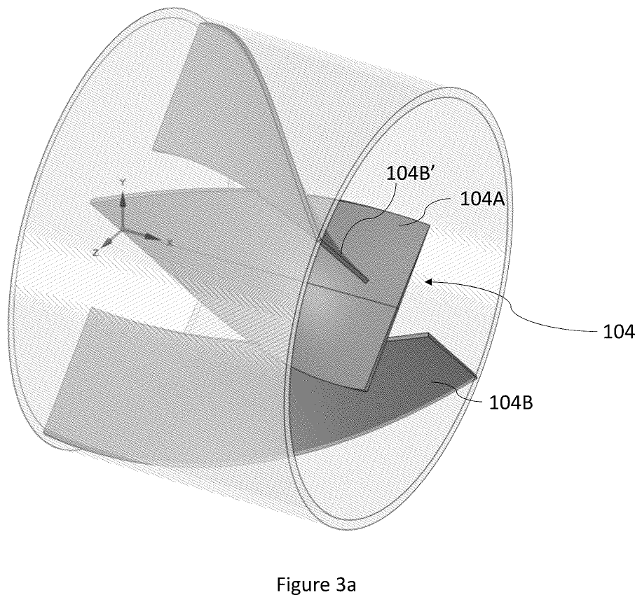

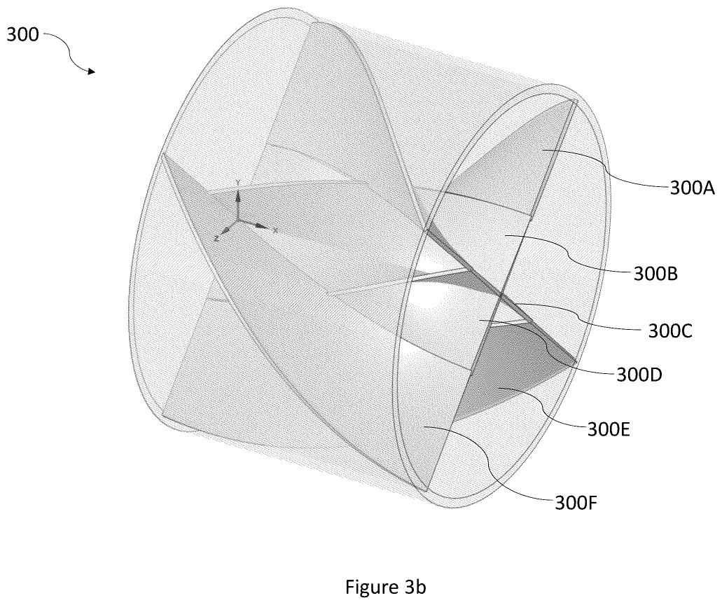

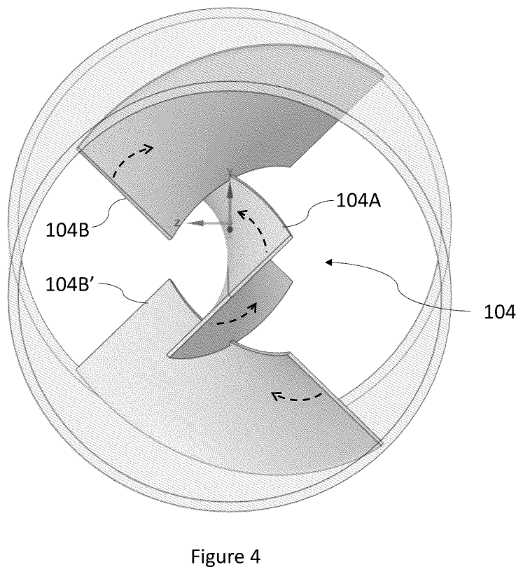

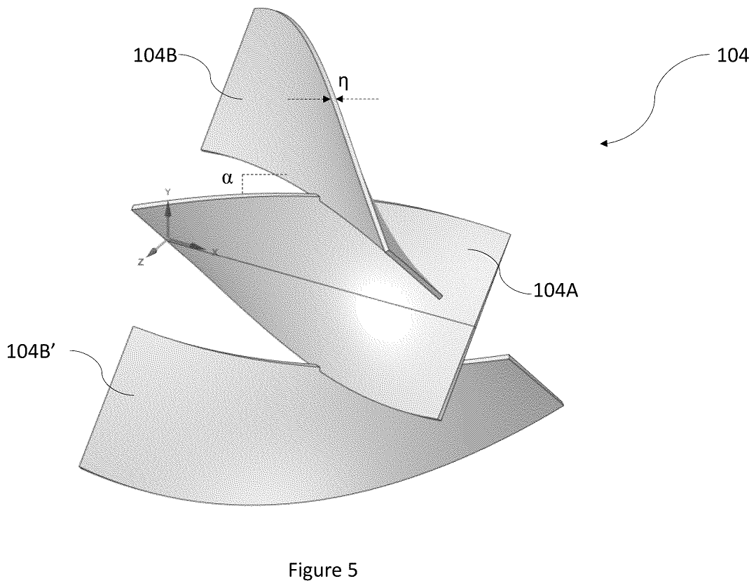

FIG. 3a illustrates a perspective view of the fluid mixing device 104, according to an embodiment of the present disclosure. FIG. 3b illustrates a perspective view of the fluid mixing device 104, according to another embodiment of the present disclosure. FIG. 4 illustrates a front view of the fluid mixing device 104 at 45 degrees elevation, according to an embodiment of the present disclosure. FIG. 5 illustrates a isometric view of the fluid mixing device 104, according to an embodiment of the present disclosure.

Referring to FIGS. 3a to 5 together, the fluid mixing device 104 may have a central blade 104A having a twisted spiral structure and a plurality of peripheral blades 104B, 104B′. Each of the plurality of peripheral blades 104B, 104B′ may also have the twisted spiral structure and may abut the central blade 104A to maintain the structural stability. The twisted spiral structure of the central blade 104A may be formed in a clock-wise or an anti-clockwise direction along a longitudinal axis XX′ depending on the desired mixing effect. Further, the twisted spiral structure of each of the plurality of peripheral blades may be formed in an opposite direction with respect to the central blade 104A along the longitudinal axis XX′. In another embodiment, a fluid mixing device 300 may have a plurality of blades (300A, 300B, 300C, 300D, 300E, 300F) joined together. Further, a shape and angle of curvature of the plurality of blades (300A, 300B, 300C, 300D, 300E, 300F) determines a mixing effect required for mixing different types of fluid streams.

In the present embodiment as illustrated in FIG. 4, the central blade 104A is twisted in an anti-clockwise direction and each of the plurality of peripheral blades 104B, 104B′ may be formed in a clockwise direction along the longitudinal axis AA′. The counter-directional spiral configuration of the central blade 104A and each of the plurality of peripheral blades 104B, 104B′ enhances the mixing action by providing additional turbulence and fluid interaction as the first fluid stream and the second fluid stream pass through the fluid mixing device 104. Hence, the central blade 104A and the plurality of peripheral blades 104B, 104B′ work in concert within the fluid mixing device 104 to intensify the blending action between two fluid streams by introducing opposing flows thereby ensuring thorough and homogenous mixing of the two fluid streams passing through the fluid mixing device 104.

The central blade 104A and the plurality of peripheral blades 104B, 104B′ may be positioned in such a way within the static mixer device 100 so that each of the plurality of peripheral blades 104B, 104B′ receive the first fluid stream, and the central blade 104A receives the second fluid stream along with the first fluid stream. The central blade 104A may have a pointed profile on a front end adapted to divide the second fluid stream into the sub streams and a curved profile along a length of the central blade 104A. As the two fluid streams flow along the length of the central blade 104A, the curved profile introduces a swirling motion to the fluids which improves the diffusion of the second fluid stream into the first fluid stream thereby promoting a thorough mixing of two fluids.

Similarly, each of the plurality of peripheral blades 104B, 104B′ may have a curved profile along a length of each peripheral blade 104B, 104B′. The curved profile of the plurality of peripheral blades 104B, 104B′ may be consistent with the design of the central blade 104A. The curved profile of the plurality of peripheral blades 104B, 104B′ ensures that the first fluid stream which is directed towards the peripheral blades may further undergo turbulent mixing and is directed towards the central blade 104A. The curved profiles of the central blade 104A and the plurality of peripheral blades 104B, 104B′ may increase a mixing efficiency by creating longitudinal swirling motion which further promotes an intermingling of the first fluid stream with the divided sub streams.

Therefore, the profiles of the central blade 104A and the plurality of peripheral blades 104B, 104B′ within the static mixer assembly 100 may be engineered to maximize the interaction between the two or more fluid streams. The pointed front end of the central blade 104A and the curved profile aid in dividing and blending of the second fluid stream with the first fluid stream. Meanwhile, the curved profiles of the plurality of peripheral blades 104B, 104B′ directs the first fluid stream towards the central blade 104A to enhance the mixing of the fluid streams passing through the fluid mixing device 104.

The central blade 104A divides the second fluid stream and the first fluid stream into sub streams and directs the divided sub streams outwardly. The plurality of peripheral blades 104B, 104B′ direct the first fluid stream towards the longitudinal axis XX′ resulting in an interaction of the first fluid stream with the divided sub streams thereby creating a swirling motion within the first fluid stream and the divided sub streams that enhance the mixing of the first fluid stream with the divided sub streams over the length of the static mixer assembly 100.

Further, each of the plurality of peripheral blades 104B, 104B′ may intersect at least one longitudinal side of the central blade 104A at a predetermined minor angle, α. The predetermined minor angle is in a range from 45 degrees to 90 degrees. In other words, the plurality of peripheral blades 104B, 104B′ approach the central blade 104A in a way that both meet at an angle rather than directly and avoid creating an obstruction for the two fluid streams. In one example, each of the plurality of peripheral blades 104B, 104B′ may intersect both the longitudinal sides of the central blade 104A.

A pitch of the central blade 104A and each of the plurality of peripheral blades 104B, 104B′ may be in a range from one to five times of a length of the central blade 104A. Also, a width of each of the plurality of peripheral blades 104B, 104B′ may be in a range from 0.1 to 0.5 times a diameter of the inner bore and the width of the central blade 104A may be in the range of 3 to 5 times of the diameter of the angular conduit 102. Further, a thickness, denoted by n, of the central blade 104A and each of the plurality of peripheral blades 104B, 104B′ may be in a range from 0.01 to 0.2 times a diameter of the inner bore.

According to the present disclosure, the aforementioned static mixer assembly 100 is designed and tested. The following examples are given to illustrate the performance of present invention and are not limited to the scope of the fluid mixing device 104.

### EXAMPLES

CFD simulations are conducted in 20 inch×1 inch (L×D) pipe. In an upstream of the static mixing assembly 100, a uniform velocity inlet of Fluid-1 (primary fluid) and Fluid-2 (secondary fluid) is introduced before the static mixer assembly 100 at 2.4 times the diameter of the inner bore and 1.6 times the diameter of the inner bore, respectively. The fluid mixing device 104 is considered at adiabatic, ambient temperature and pressure. In a downstream of the static mixer device 100, pressure is imposed as zero boundary condition, which is placed 20 times the diameter of the inner bore of the static mixer assembly 100. The chosen dimension of the fluid mixing device 104, fluid flow properties as described in Example-1 and Example-2, is of exemplary embodiments only and not limited to an applicability of the static mixing assembly 100.

### Example 1

Each CFD simulation is performed at different mixed Reynold's number and considered, density of Fluid-2 is greater than that of Fluid-1. The feed properties of fluids at elevated temperature of 200° C. are mentioned in Table-1. Since, the primary objective of the present invention is to provide the fluid mixing device 104, which may achieve homogenous mixing of an injected fluid at a shorter distance with lesser pressure drop. The static mixing assembly 100 is benchmarked with a conventional Kenics static mixer. Table-2 shows the performance of the static mixing assembly 100 in terms of pressure drop (ΔP) and co-efficient of variance (CoV).

TABLE 1

| Properties | Fluid-1 | Fluid-2 |
|---|---|---|
| Density, kg/m³ | 710 | 860 |
| Viscosity, kg/ms | 0.0006248 | 0.00258 |

TABLE 2

| | Benchmark | | Present Invention | |
|---|---|---|---|---|
| Re | ΔP, Pa | CoV | ΔP, Pa | CoV |
| 10000 | 99 | 0.0055 | 93 | 0.0048 |
| 25000 | 541 | 0.0016 | 501 | 0.0012 |
| 50000 | 2016 | 0.0014 | 1857 | 0.0009 |
| 100000 | 7654 | 0.0015 | 7060 | 0.0006 |
| 300000 | 64846 | 0.0015 | 59735 | 0.0005 |

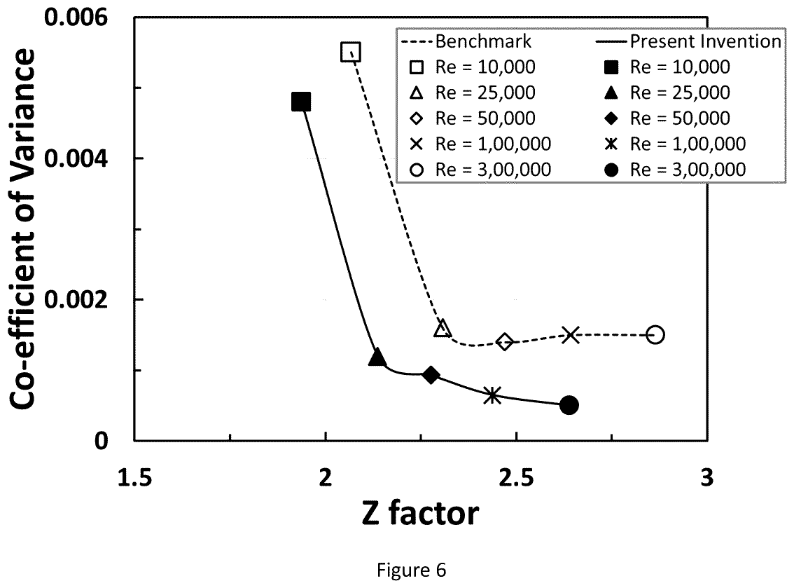

As shown in Table-2, an increase in Reynold's number increases the pressure drop and decreases the CoV. FIG. 6 illustrates the performance of the conventional static mixer, with the static mixer assembly, 100, according to an embodiment of the present disclosure. As illustrated in FIG. 6, the static mixer assembly 100 shows excellent mixing with less pressure drop (Z-factor represents the ratio of pressure drop with and without static mixer) over the conventional mixer.

### Example 2

As in case of additives and/or diluent density is lower than that of primary stream inline, this example tested. The chosen Fluid-1 (Primary) and Fluid-2 (Secondary) properties are shown in Table-3. The performance of the static mixer assembly, 100, was evaluated at 300000 Reynolds number in terms of pressure drop (ΔP) and co-efficient of variance (CoV) is provided in Table-4.

TABLE 3

| Properties | Fluid-1 | Fluid-2 |
|---|---|---|
| Density, kg/m³ | 860 | 710 |
| Viscosity, kg/ms | 0.00258 | 0.0006248 |

TABLE 4

| | Benchmark | | Present Invention | |
|---|---|---|---|---|
| Re | ΔP, Pa | CoV | ΔP, Pa | CoV |
| 300000 | 846048 | 0.0024 | 787160 | 0.0009 |

As shown in Table-4, the static mixer assembly 100 shows an excellent mixing with less pressure drop over the benchmark static mixer.

The present disclosure discloses the fluid mixing device 104 having twisted spiral structures on both the central blade 104A and the plurality of peripheral blades 104B, 104B′ which ensures highly efficient blending of two fluid streams, resulting in a homogeneous fluid mixture. Further, the angular intersection of the central blade 104A and the plurality of peripheral blades 104B, 104B′ at controlled angles enhances turbulence and fluid interactions thereby facilitating thorough mixing.

Further, the present invention provides precise control over the mixing process, allowing for customization through choices of spiral directions and blade angles. The present invention achieves effective mixing with minimal pressure drop thereby enhancing energy efficiency. With reduced maintenance requirements due to an absence of moving parts, the present disclosure is durable and cost-effective.

Unless otherwise defined, all technical and scientific terms used herein have the same meaning as commonly understood by one ordinary skilled in the art to which this invention belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

We claim:

1. A fluid mixing device comprising:
a central blade having a twisted spiral structure; and
a plurality of peripheral blades, each having the twisted spiral structure and abuts the central blade,
wherein the twisted spiral structure of the central blade is formed in a clockwise or an anti-clockwise direction along a longitudinal axis and the twisted spiral structure of each of the plurality of peripheral blades is formed in an opposite direction with respect to the central blade along the longitudinal axis.

2. The fluid mixing device as claimed in claim 1, wherein the plurality of peripheral blades receives a first fluid stream, the central blade receives a second fluid stream along with the first fluid stream.

3. The fluid mixing device as claimed in claim 2, wherein the central blade divides the second fluid stream and the first fluid stream into sub streams and directs the divided sub streams outwardly, and the plurality of peripheral blades directs the first fluid stream towards the longitudinal axis resulting in an interaction of the first fluid stream with the divided sub streams thereby creating a swirling motion within the first fluid stream and the divided sub streams.

4. The fluid mixing device as claimed in claim 2, wherein the central blade has a pointed profile on a front end adapted to divide the second fluid stream into the sub streams and a curved profile along a length of the central blade.

5. The fluid mixing device as claimed in claim 1, wherein each of the plurality of peripheral blades intersects at least one longitudinal side of the central blade at a predetermined minor angle, the predetermined minor angle is in a range from 45 degrees to 90 degrees.

6. The fluid mixing device as claimed in claim 1, wherein a pitch of the central blade and each of the plurality of peripheral blades is in a range from one to five times a length of the central blade.

7. A static mixer assembly having an inner bore for mixing a first fluid stream and a second fluid stream comprising:
an upstream end adapted to allow ingress of the first fluid stream therethrough;
a downstream end opposite to the upstream end, the downstream end adapted to allow egress of a mixture of the first fluid stream and a second fluid stream therethrough; and
an angular conduit disposed in the inner bore and downstream to the upstream end, and adapted to provide the second fluid stream into the inner bore; and
a fluid mixing device installed inside the inner bore, downstream to the angular conduit and upstream to the downstream end, comprising:
a central blade having a twisted spiral structure; and a plurality of peripheral blades, each having the twisted spiral structure and abuts the central blade,
wherein
the twisted spiral structure of the central blade is formed in a clockwise or an anti-clockwise direction along a longitudinal axis and the twisted spiral structure of each of the plurality of peripheral blades is formed in an opposite direction with respect to the central blade along the longitudinal axis.

8. The static mixer assembly as claimed in claim 7, wherein the plurality of peripheral blades receives the first fluid stream, and the central blade receives the second fluid stream along with the first fluid stream.

9. The static mixer assembly as claimed in claim 8, wherein the central blade divides the second fluid stream and the first fluid stream into sub streams and directs the divided sub streams outwardly, and the plurality of peripheral blades directs the first fluid stream towards the longitudinal axis resulting in an interaction of the first fluid stream with the divided sub streams thereby creating a swirling motion within the first fluid stream and the divided sub streams.

10. The static mixer assembly as claimed in claim 7, wherein the central blade has a pointed profile on a front end adapted to divide the second fluid stream into the sub streams and a curved profile along a length of the central blade.

11. The static mixer assembly as claimed in claim 7, wherein each of the plurality of peripheral blades intersects at least one longitudinal side of the central blade at a predetermined minor angle, the predetermined minor angle is in a range from 45 degrees to 90 degrees.

12. The static mixer assembly as claimed in claim 7, wherein a pitch of the central blade and each of the plurality of peripheral blades is in a range from one to five times a length of the central blade.

13. The static mixer assembly as claimed in claim 7, wherein a width of each of the plurality of peripheral blades is in a range from 0.1 to 0.5 times a diameter of the inner bore and the width of the central blade is in the range of 3 to 5 times of a diameter of the angular conduit.

14. The static mixer assembly as claimed in claim 7, wherein a thickness of the central blade and each of the plurality of peripheral blades is in a range from 0.01 to 0.2 times a diameter of the inner bore.

15. The static mixer assembly as claimed in claim 7, wherein the angular conduit having an L-shaped profile comprises an inlet adapted to ingress the second fluid stream and an outlet adapted to egress the second fluid stream.

16. The static mixer assembly as claimed in claim 15, wherein a distance between the inlet of the angular conduit and the fluid mixing device is in a range from 0.5 to 5 times a diameter of the inner bore.

17. The static mixer assembly as claimed in claim 7, wherein the angular conduit is adapted to supply the second fluid stream coaxial to the longitudinal axis.

18. The static mixer assembly as claimed in claim 7, wherein an aspect ratio of the fluid mixing device is in a range from 0.5 to 2 times a diameter of the inner bore.

19. The static mixer assembly as claimed in claim 1, for viscous fluids and for a wide range of Reynold's number till 400000.
